(19) United States
(12) Patent Application Publication
(10) Pub. No.: US 2025/0056251 A1
(43) Pub. Date: Feb. 13, 2025

(54) TRIGGERING OF ARTIFICIAL INTELLIGENCE/MACHINE LEARNING TRAINING IN NETWORK DATA ANALYTICS FUNCTION

(71) Applicant: Nokia Technologies Oy, Espoo (FI)

(72) Inventors: Sakira HASSAN, Espoo (FI); Endrit DOSTI, Espoo (FI); Jerediah FEVOLD, Naperville, IL (US); István Zsolt KOVÁCS, Aalborg (DK)

(21) Appl. No.: 18/785,480

(22) Filed: Jul. 26, 2024

Related U.S. Application Data
(60) Provisional application No. 63/531,966, filed on Aug. 10, 2023.

(51) Int. Cl. H04W 24/02; H04W 24/10

(52) U.S. Cl. CPC H04W 24/02; H04W 24/10

(57) ABSTRACT

Triggering of artificial intelligence/machine learning training in a network data analytics function is provided. A method for triggering artificial intelligence/machine learning training in a network data analytics function may include obtaining at least one machine learning model for training or retraining based on measurement data of a network. The method may also include determining that data collection is required prior to training or retraining the at least one machine learning model, and receiving one or more measurement reports that includes at least one dataset from the data collection. The method may further include determining whether additional assisted information from one or more network devices is required for training or retraining. The at least one machine learning model may be trained or retrained based on all collected datasets, which includes the at least one dataset from the data collection.

### RELATED APPLICATION

This application claims priority to U.S. provisional Application No. 63/531,966 filed Aug. 10, 2023, which is incorporated herein by reference in its entirety.

### TECHNICAL FIELD

Some example embodiments may generally relate to mobile or wireless telecommunication systems, such as Long Term Evolution (LTE) or fifth generation (5G) new radio (NR) access technology, or sixth generation (6G technology), or other communications systems. For example, certain example embodiments may relate to triggering of artificial intelligence/machine learning training in network data analytics function.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions that, when executed by the at least one processor, cause the apparatus at least to obtain, from a network entity, at least one machine learning model for training or retraining based on measurement data of a network. The apparatus may also be caused to determine that data collection is required prior to training or retraining the at least one machine learning model, and receive, from a network function, one or more measurement reports that comprises at least one dataset from the data collection. The apparatus may further be caused to determine whether additional assisted information from one or more network devices is required for training or retraining and train or retrain the at least one machine learning model based on all collected datasets, which comprises the at least one dataset from the data collection.

Certain exemplary embodiments may provide an apparatus including at least one processor and at least one memory storing instructions that, when executed by the at least one processor, cause the apparatus at least to determine that at least one machine learning model requires updates and transmit, to a network entity, a request for training or retraining the at least one machine learning model. The apparatus may also be caused to provide, to the network entity, at least one measurement report indicating performance of a user equipment and receive, from the network entity, a trained or retrained machine learning model to be executed on the apparatus.

Some exemplary embodiments may provide a method including obtaining, by an apparatus from a network entity, at least one machine learning model for training or retraining based on measurement data of a network. The method may also include determining that data collection is required prior to training or retraining the at least one machine learning model, and receiving, from a network function, one or more measurement reports that comprises at least one dataset from the data collection. The method may further include determining whether additional assisted information from one or more network devices is required for training or retraining, and training or retraining the at least one machine learning model based on all collected datasets, which comprises the at least one dataset from the data collection.

Certain exemplary embodiments may provide a method including determining, by an apparatus, that at least one machine learning model requires updates and transmitting, to a network entity, a request for training or retraining the at least one machine learning model. The method may also include providing, to the network entity, at least one measurement report indicating performance of a user equipment and receiving, from the network entity, a trained or retrained machine learning model to be executed on the apparatus.

Various exemplary embodiments may provide an apparatus including means for obtaining, from a network entity, at least one machine learning model for training or retraining based on measurement data of a network. The apparatus may also include means for determining that data collection is required prior to training or retraining the at least one machine learning model, and means for receiving, from a network function, one or more measurement reports that comprises at least one dataset from the data collection. The apparatus may further include means for determining whether additional assisted information from one or more network devices is required for training or retraining, and means for training or retraining the at least one machine learning model based on all collected datasets, which comprises the at least one dataset from the data collection.

Some exemplary embodiments may provide an apparatus including means for determining, by an apparatus, that at least one machine learning model requires updates, and means for transmitting, to a network entity, a request for training or retraining the at least one machine learning model. The apparatus may also include means for providing, to the network entity, at least one measurement report indicating performance of a user equipment and means for receiving, from the network entity, a trained or retrained machine learning model to be executed on the apparatus.

Certain exemplary embodiments may provide a non-transitory computer readable medium comprising program instructions that, when executed by an apparatus, cause the apparatus at least to obtain, from a network entity, at least one machine learning model for training or retraining based on measurement data of a network. The apparatus may also be caused to determine that data collection is required prior to training or retraining the at least one machine learning model, and receive, from a network function, one or more measurement reports that comprises at least one dataset from the data collection. The apparatus may further be caused to determine whether additional assisted information from one or more network devices is required for training or retraining, and train or retrain the at least one machine learning model based on all collected datasets, which comprises the at least one dataset from the data collection.

Various exemplary embodiments may provide a non-transitory computer readable medium comprising program instructions that, when executed by an apparatus, cause the apparatus at least to determine that at least one machine learning model requires updates and transmit, to a network entity, a request for training or retraining the at least one machine learning model. The apparatus may also be caused to provide, to the network entity, at least one measurement report indicating performance of a user equipment, and receive, from the network entity, a trained or retrained machine learning model to be executed on the apparatus.

Certain exemplary embodiments may provide one or more computer programs including instructions stored thereon for performing one or more of the methods described herein. Some exemplary embodiments may also provide one or more apparatuses including one or more circuitry configured to perform one or more of the methods described herein.

### BRIEF DESCRIPTION OF THE DRAWINGS

For proper understanding of example embodiments, reference should be made to the accompanying drawings, as follows:

FIG. 1 illustrates an example of a signaling diagram of signaling-based MDT procedures;

FIG. 2 illustrates an example of a signaling diagram for configuring signaling-based MDT;

FIG. 3 illustrates an example of a flow diagram for triggering AI/ML training or retraining using MDT, according to various exemplary embodiments;

FIG. 4A illustrates a signaling diagram for one or more procedures to trigger training or retraining of the model, according to some exemplary embodiments;

FIG. 4B illustrates a signaling diagram, which is a continuation of FIG. 4A, for one or more procedures to trigger training or retraining of the model, according to some exemplary embodiments;

FIG. 5 illustrates an example of a signaling diagram for one or more procedures for direct data forwarding and configuration reporting, according to certain exemplary embodiments;

FIG. 6 illustrates an example of a flow diagram of a method, according to various exemplary embodiments;

FIG. 7 illustrates an example of a flow diagram of another method, according to some exemplary embodiments; and

FIG. 8 illustrates a set of apparatuses, according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for triggering of an artificial intelligence/machine learning (AI/ML) training procedure in network data analytics function (NWDAF). Although the devices discussed below and shown in the figures refer to 5G or Next Generation NodeB (gNB) devices, network devices, and user equipment (UE), this disclosure is not limited to only gNBs, UEs, and the network elements referred to herein. For example, the following description may also apply to any type of network device or element and UE.

5G/NR networks may have the capability to support a variety of communication services, such as Internet of Things (IoT) and Enhanced Mobile Broadband (eMBB). A significant amount of data related to network and service events and status may be required to be analyzed and processed.

Data collection may be particularly useful to enable artificial intelligent or machine learning (AI/ML) in an NR air interface. Certain existing or legacy data collection procedures in the 5G network may not be sufficient to train an AI/ML model in a gNB or radio access network (RAN) and perform subsequent model updating/finetuning. MDT may be used to collect RAN related measurements from one or more UE and may report the measurements, via, for example, a measurement report, to the gNB. MDT may include signaling-based MDT and/or management-based MDT, which both may require a user to consent to the MDT before activating the MDT functionality because of privacy and legal obligations. An owner or operator of the device(s) to perform the MDT procedures may be required to collect this user consent prior to performing the MDT procedures. Information related to user consent may be accessible as a part of subscription data and may be stored in a unified data management (UDM) database.

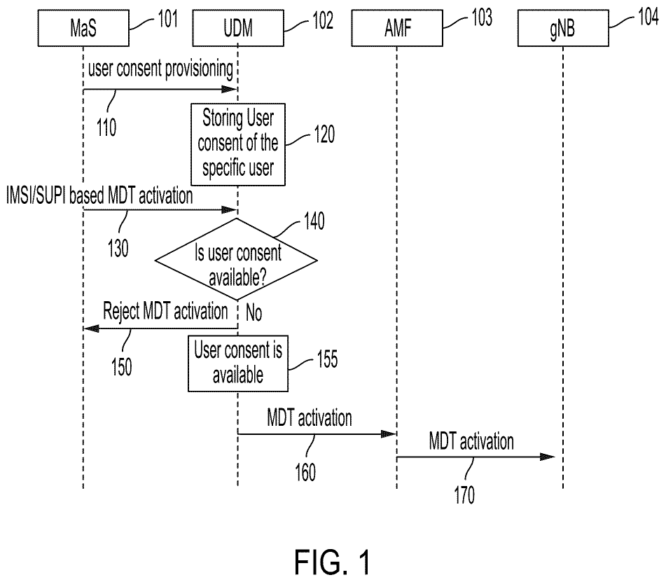

FIG. 1 illustrates an example of a signaling diagram of signaling-based MDT procedures to facilitate accessing or obtaining user consent. A network configuration in the example of FIG. 1 may include a management service (MaS) function 101, a UDM 102, an access and mobility function (AMF) 103, and a base station or network node, such as a gNB 104. The procedures for signaling-based MDT may include, at 110, the MaS 101 may provide user consent provisioning to the UDM 102, and at 120, the UDM 102 may store user consent for a specific user.

At 130, the MaS 101 may provide minimization of drive tests (MDT) activation based on an international mobile subscriber identity (IMSI) and/or a subscription permanent identifier (SUPI) to the UDM 102, and at 140, the UDM 102 may determine whether user consent is available. At 150, if user consent is determined to not be available or has not been given, the UDM 102 may reject the MDT activation and notify the MaS 101 of the rejection. At 155, if user consent is determined to be available, the UDM 102 may, at 160, perform MDT activation with the AMF 103. At 170, the gNB 104 may also perform MDT activation and the AMF 103 may send an activation message.

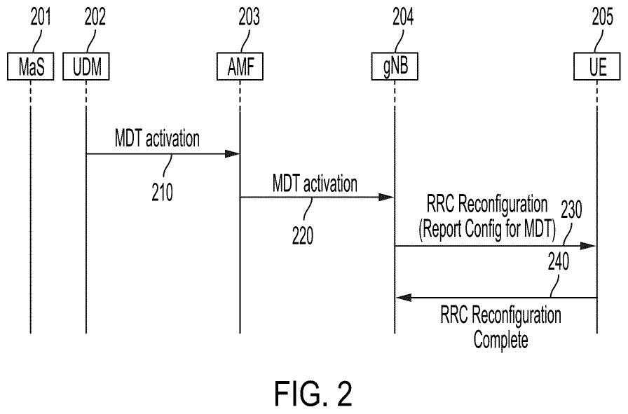

FIG. 2 illustrates an example of a signaling diagram for configuring signaling-based MDT in a UE after confirming consent by a user. A network configuration in the example of FIG. 2 may include a MaS 201, a UDM 202, an AMF 203, a base station or network node, such as a gNB 204, and a UE 205. The procedures for configuring the signaling-based MDT in the UE 205 may include, at 210, the UDM 202 may perform MDT activation with the AMF 203, and at 220, the AMF 203 may perform MDT activation with the gNB 204.

At 230, the gNB 204 may perform radio resource control (RRC) reconfiguration with the UE 205, which may include reporting a configuration for the MDT. At 240, the UE 205 may complete the RRC reconfiguration with the gNB 204.

Various exemplary embodiments may provide advantages and/or improvements to legacy MDT configuration procedures by, for example, implementing NWDAF and triggering data collection of RAN measurements through MDT for offline AI/ML model training or retraining.

Certain exemplary embodiments may provide for triggering an offline training or retraining in the NWDAF and/or the gNB for a UE side, a network entity (NW) side, and/or for two-sided AI/ML models. The training or retraining may be triggered by triggering MDT to collect physical layer measurements, which may be provided to the NWDAF or gNB by the UE.

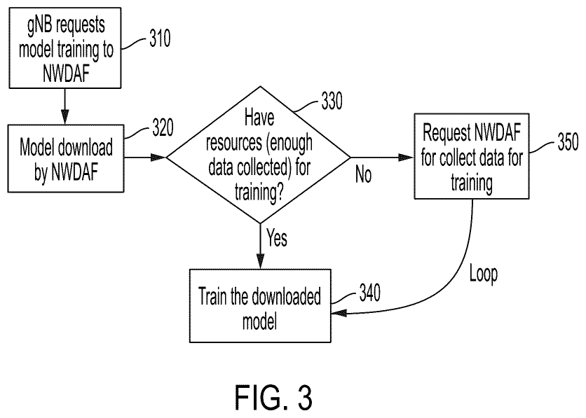

FIG. 3 illustrates an example of a flow diagram for triggering AI/ML training or retraining using MDT, according to various exemplary embodiments. The procedures may include, for example, at 310, a gNB may transmit, to an NWDAF, a request for training or retraining of one or more ML models for an AI/ML enabled feature or feature group. At 320, the training or retraining request may trigger a request for a model to be downloaded to the NWDAF from a provider, such as a UE, the gNB, a location management function (LMF), an operations and management (OAM) node, a core network (CN) node, and/or an over-the-top (OTT) server. At 330, the NWDAF may provide an acknowledgement to the provider providing the model(s), upon receiving the model(s), and may determine whether the NWDAF has a required number of resources or has collected a preconfigured amount of data to perform training of the downloaded model(s). If the provider is not the gNB, the provider may forward the acknowledgement of the reception of the model(s) from the NWDAF to the gNB.

At 340, the NWDAF may train or retrain the downloaded model(s) if the NWDAF determines that the NWDAF has a predetermined number of resources or has collected a predetermined amount of data to perform the training or retraining. The predetermined number of resources may be, for example, number of CPU/GPUs, an amount of memory, a signalling/interface bandwidth, and/or the like. At 350, if the NWDAF may not have the predetermined number of resources or may have not collected the predetermined amount of data to perform the training or retraining, the NWDAF may request an MaS to provide additional training data for training or retraining the downloaded AI/ML model(s). This process may repeat until the NWDAF determines that the NWDAF has a predetermined number of resources or has collected a predetermined amount of data to perform the training or retraining at procedure 340.

Various exemplary embodiments may provide one or more procedures for training or retraining in a NW entity for models for a UE-side, a UE part, an NW side, and/or an NW part. The one or more procedures may include, for example, the NW entity, such as an NWDAF, may download the AI/ML model and may begin to initiate training for the model based on a configuration of various resources, such as availability of computational resources, and a memory capacity for loading models and data. The NWDAF may assess the data collection availability and sufficiency, e.g., whether a predetermined amount of data has been collected, and may determine whether additional assisted information needed from different NW entities and/or the UE may be collected and added to the data collection for training or retraining.

The AI/ML model(s) may be trained, or retrained, either parallel or sequentially with different provided hyperparameters and may validate the AI/ML model(s) to select a model from candidate models based on the hyperparameters. The NWDAF may then forward the trained model and data to different network entities of future usage.

Certain exemplary embodiments may provide an initial training phase in which the NWDAF may train an untrained model, which has not been trained when the NWDAF has both the computational resources and data needed. The gNB may initialize the training model, or a collection of models, for an AI/ML enabled feature and/or functionality. Initializing the training model may trigger a request to NWDAF. The initialization request may be triggered by the UE, the LMF or the gNB. The NWDAF may download target model(s) from the gNB, a CN node, an OAM node, the LMF, and/or the OTT server. The NWDAF may not be a permanent storage. Upon receiving the downloaded model(s), the NWDAF may acknowledge receiving the model(s). The NWDAF may assess or determine whether data collection is needed, and if so, may request training data from the MaS. The NWDAF may then perform the AI/ML training of the model(s).

Some exemplary embodiments may provide a retraining phase. The gNB, the UE, and/or the LMF may monitor the performance of one or more models. During monitoring, the gNB, the UE, and/or the LMF may evaluate the performance of the one or more models. For example, the evaluation of the models based on the monitoring may be decided at the gNB. If one or more key performance indicators (KPIs) of the performance evaluation may not be considered to be satisfactory, the gNB may request for retraining or updating of the one or more models. The retraining or updating or the one or more models would be performed by providing the one or more models to the NWDAF and may trigger data collection procedures in the NWDAF.

In addition, or as an alternative, the gNB, or an ML training capable network entity, may perform a relatively reduced processes of updating and/or finetuning of the initially trained model received from the NWDAF. The data collection procedures in the NWDAF may still be triggered and data may be also collected in the gNB, or the ML training capable network entity.

Certain exemplary embodiments may reduce the signaling and resource overhead over the NR air interface by, for example, the gNB forwarding the data used for fine tuning to the NWDAF. Alternatively, in some exemplary embodiments, the NWDAF may not be required to perform the updating and/or finetuning. The reduction in the signaling and resource overhead over the NR air interface may reduce the delay with which the new model is available at the gNB and/or UE.

After the one or more models has been updated or finetuned by the gNB, or the AI/ML training capable entity, the gNB may deliver the one or more models to the NWDAF to be available for subsequent operations, such as additional finetuning and adaptation, federation, knowledge distillation, and/or the like. For UE-side or UE-part models, the data collection may be triggered by the UE where the UE may request to the gNB for the types of measurement data that the UE may report to the gNB for model retraining.

Various exemplary embodiments may provide that the MaS may create an MDT activation session involving the UDM, the AMF, and/or the gNB. For example, the gNB may configure the MDT session to the UE. After establishing RRC connection, the UE may log measurement reports and may send the measurement reports to the gNB. The gNB forwards measurement logs to a trace collection entity (TCE). The TCE may forward the measurement logs to the NWDAF. The NWDAF may perform training and validation on the collected data. If the training entity, such as the gNB, LMF, or the like, is different from the NWDAF, the training and validation may be performed in the gNB and/or the LMF. After the training or retraining is complete, the one or more models may be delivered to the gNB, the UE, the LMF, the CN, and/or the OTT server for evaluation or storage.

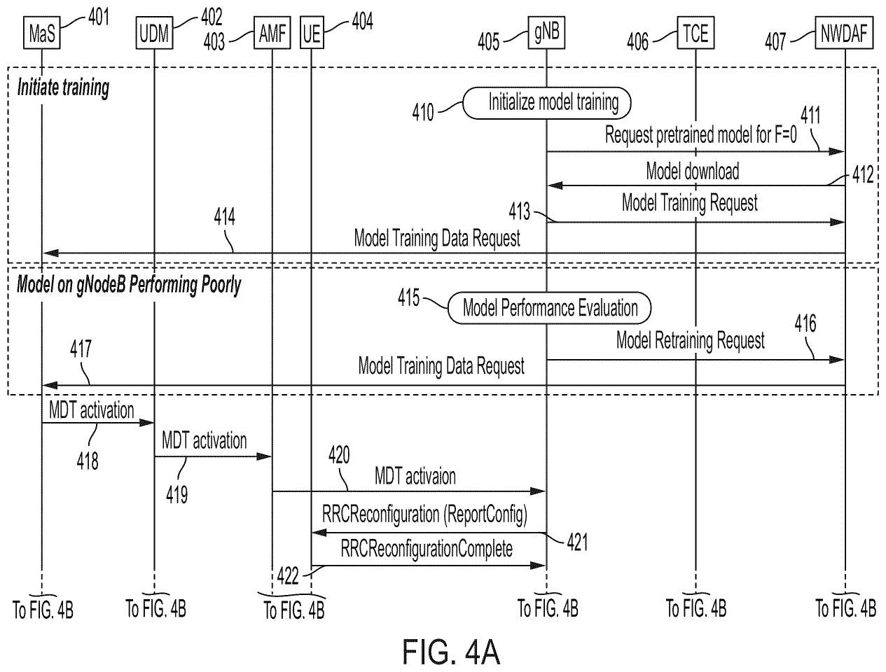

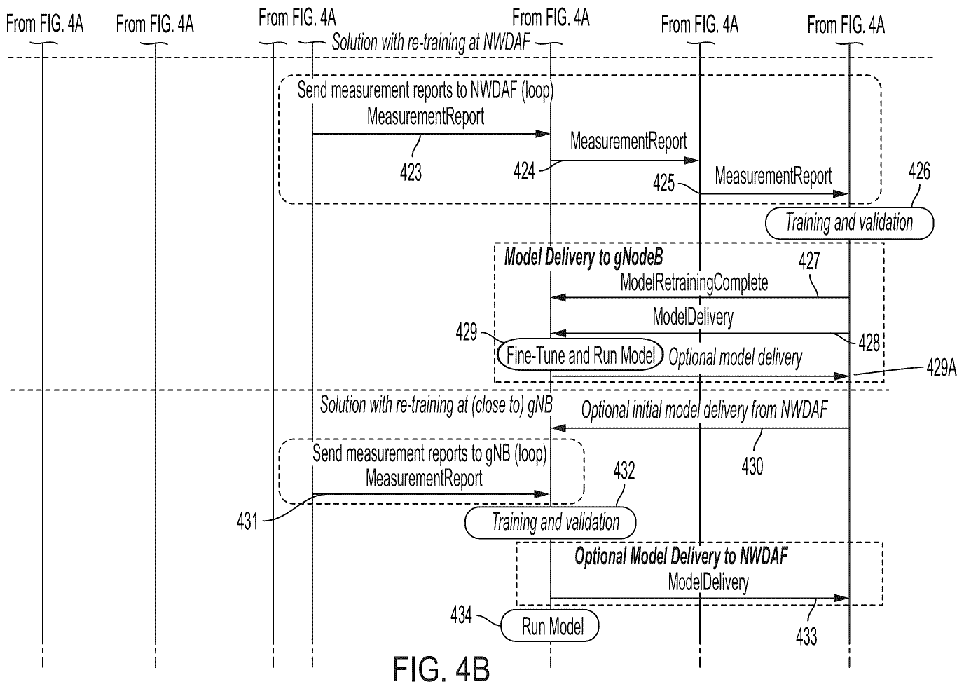

FIGS. 4A and 4B illustrate a signaling diagram for one or more procedures to trigger training or retraining of the model, according to certain exemplary embodiments. A network configuration in the example of FIGS. 4A and 4B may include a MaS 401, a UDM 402, an AMF 403, a UE 404, a base station or network node, such as a gNB 405, a TCE 406, and an NWDAF 407. As shown in FIG. 4A, the procedures for training or retraining the model may include, at 410, the gNB 405 may initialize the ML model training procedure, and at 411, the gNB 405 may request to the NWDAF 407 for a previously trained model. At 412, the NWDAF 407 may download the model to the gNB 405, and at 413, the gNB 405 may send a request for training the model to the NWDAF 407.

At 414, the NWDAF 407 may send a training data collection request to the MaS 401. At 415, the gNB 405 may perform a performance evaluation of the model and may determine that the model may be performing poorly. At 416, the gNB 405 may send a retraining request for the model to the NWDAF 407, and at 417, the NWDAF 407 may send, to the MaS, a request for training data collection for the model. At 418, the MaS 401 may send an MDT activation to the UDM 402, and at 419, the UDM 402 may send an MDT activation to the AMF 403. At 420, the AMF 403 may send an MDT activation to the gNB 405, and at 421, the gNB 405 may perform RRC reconfiguration with the UE 404. At 422, the UE 404 may complete the RRC configuration with the gNB 405.

As shown in FIG. 4B, the following operations 423-425 may be performed on a loop. At 423, the UE 404 may send a measurement report to the gNB 405. At 424, the gNB 405 may send a measurement report to the TCE 406, and at 425, the TCE 406 may send a measurement report to the NWDAF 407. At 426, the NWDAF 407 may perform training and validation of the model.

The following operations 427-429 may be performed as a sub-operation between the NWDAF 407 and the gNB 405. At 427, the NWDAF 407 may send, to the gNB 405, a notification that the training of the model is completed, and at 428, the NWDAF 407 may deliver the trained model to the gNB 405. At 429, the gNB 405 may re-train or fine-tune and run the trained model from the NWDAF 407 based on UE data from the measurement reports, and at 429A, the gNB 405 may transmit the newly trained model to the NWDAF 407 for storage or distribution to other UEs.

At 430, the NWDAF 407 may optionally provide an initial delivery of the model to the gNB 405, and at 431, the UE 404 may send measurement reports to the gNB 405, which may occur on a loop, repeatedly, or at reoccurring intervals. At 432, the gNB 405 may train and validate the model based on data in the measurement report. At 433, the gNB 405 may deliver the model to the NWDAF 407, and at 434, the gNB 405 may execute the model.

Some exemplary embodiments may provide an alternative in which instead of the TCE 406 forwarding the measurement reports to the NWDAF 407, the gNB 405 may directly forward the measurement report to the NWDAF 407. This may result in faster data collection for training purposes in certain situations.

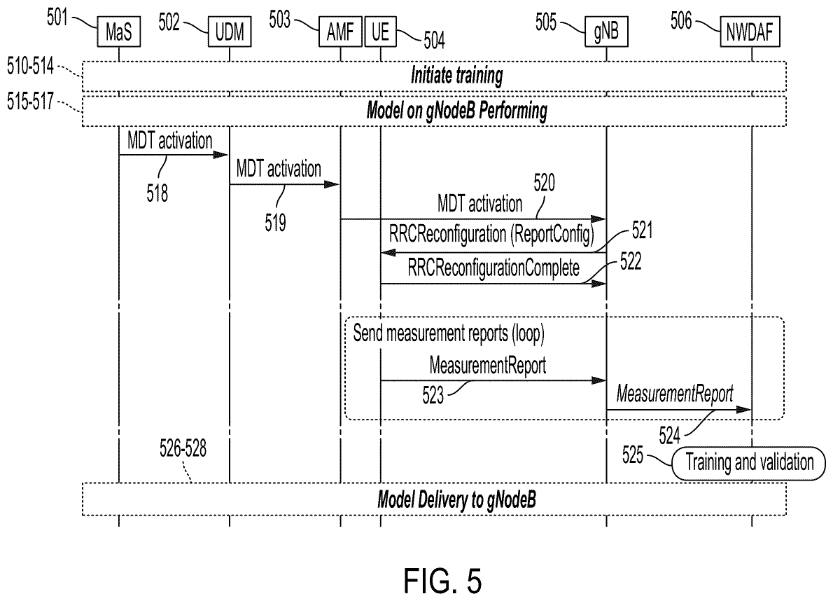

FIG. 5 illustrates an example of a signaling diagram for one or more procedures for direct data forwarding, according to certain exemplary embodiments. A network configuration in the example of FIG. 5 may include a MaS 501, a UDM 502, an AMF 503, a UE 504, a base station or network node, such as a gNB 505, and an NWDAF 506. The procedures for training or retraining the model may include, at 510, the gNB 505 may initialize the ML model training procedure, and at 511, the gNB 505 may request to the NWDAF 506 for a previously trained model. At 512, the NWDAF 506 may download the model to the gNB 505, and at 513, the gNB 505 may send a request for training the model to the NWDAF 506.

At 514, the NWDAF 506 may send a model training request to the MaS 501, and at 515, the gNB 505 may perform a performance evaluation of the model and may determine that the model may be performing poorly. At 516, the gNB 505 may send a retraining request for the model to the NWDAF 506, and at 517, the NWDAF 506 may send, to the MaS 501, a request for training data collection for the model. At 518, the MaS 501 may send an MDT activation to the UDM 502, and at 519, the UDM 502 may send an MDT activation to the AMF 503. At 520, the AMF 503 may send an MDT activation to the gNB 505, and at 521, the gNB 505 may perform RRC reconfiguration with the UE 504. At 522, the UE 504 may complete the RRC configuration with the gNB 505, and at 523, the UE 504 may send a measurement report to the gNB 505. At 524, the gNB 505 may send a measurement report to the NWDAF 506. At 525, the NWDAF 506 may perform training and validating of the model.

At 526, the NWDAF 506 may send, to the gNB 505, a notification that the training of the model is completed, and at 527, the NWDAF 506 may deliver the trained model to the gNB 505. At 528, the gNB 505 may apply and/or execute the trained model.

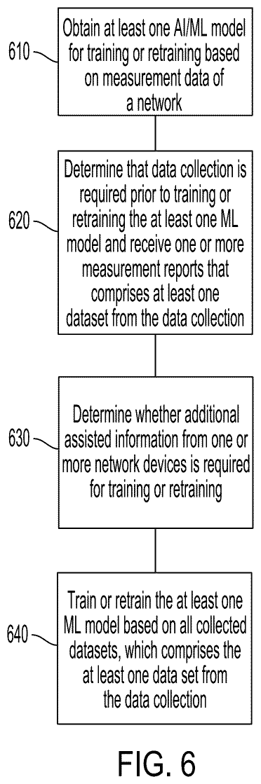

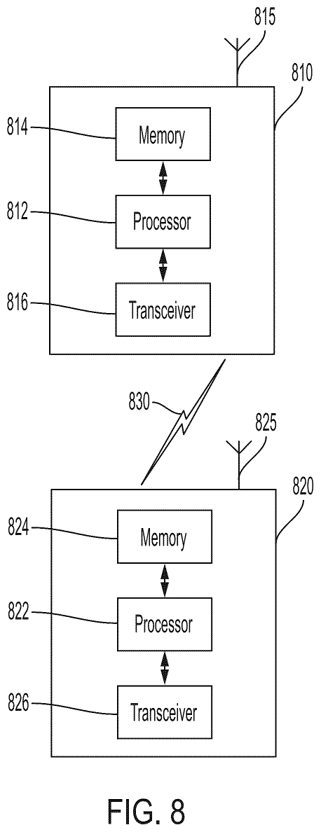

FIG. 6 illustrates an example flow diagram of a method, according to certain exemplary embodiments. In some example embodiments, the method of FIG. 6 may be performed by a network node, network element, or a group of multiple network nodes or elements in a 3GPP system, such as LTE or 5G-NR. For instance, in some exemplary embodiments, the method of FIG. 6 may be performed by a NWDAF similar to apparatus 810 illustrated in FIG. 8.

According to various exemplary embodiments, the method of FIG. 6 may include, at 610, obtaining, from a network entity, at least one machine learning model for training or retraining based on measurement data of a network. At 620, the method may include determining that data collection is required prior to training or retraining the at least one machine learning model, and receiving, from a network function, one or more measurement reports that comprises at least one dataset from the data collection. The method may also include, at 630, determining whether additional assisted information from one or more network devices is required for training or retraining. At 640, the method may include training or retraining the at least one machine learning model based on all collected datasets, which comprises the at least one dataset from the data collection.

Some exemplary embodiments may provide that the method also includes receiving one or more additional machine learning models to be trained or retrained in the future. The obtained machine learning model for training or retraining may be selected from a plurality of machine learning models accessible to the apparatus 810. The method may include transmitting an acknowledgement to a network entity from which the apparatus obtained the at least one machine learning model for training or retraining. The method may also validate the trained model based on the one or more measurement reports.

Certain exemplary embodiments may provide that the method also includes providing the trained model to a network device or a user equipment. The method may further include receiving, from the network entity, a request for retraining the at least one machine learning model, transmitting, to the network function, a request for training data for the at least one machine learning model to be retrained, and retraining the machine learning model based on the requested training data.

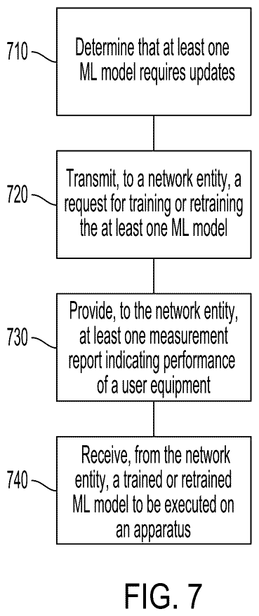

FIG. 7 illustrates an example flow diagram of a method, according to certain exemplary embodiments. In some example embodiments, the method of FIG. 7 may be performed by a network node, network element, or a group of multiple network nodes or elements in a 3GPP system, such as LTE or 5G-NR. For instance, in some exemplary embodiments, the method of FIG. 7 may be performed by a base station or gNB similar to apparatus 820 illustrated in FIG. 8.

According to various exemplary embodiments, the method of FIG. 7 may include, at 710, determining that at least one machine learning model may require updates, and at 720, the method may include transmitting, to a network entity, a request for training or retraining the at least one machine learning model. At 730, the method may further include providing, to the network entity, at least one measurement report indicating performance of a user equipment, and at 740, receiving a trained or retrained model to be executed on the apparatus 820.

Certain exemplary embodiments may provide that the method may further include receiving one or more additional machine learning models to be trained or retrained in the future. The obtained machine learning model for training or retraining may be selected from a plurality of machine learning models accessible to the apparatus 820. The method may also include validating the trained machine learning model based on the one or more measurement reports and executing the trained machine learning model. The method may further include providing, to the network entity, a request for retraining the at least one machine learning model, receiving one or more measurement reports that include at least one dataset for retraining the at least one machine learning model, and retraining the machine learning model based on the one or more measurement reports.

FIG. 8 illustrates a set of apparatuses 810 and 820 according to various exemplary embodiments. In the various exemplary embodiments, the apparatus 810 may be may be a network, network entity, element of the core network, or element in a communications network or associated with such a network. For example, NWDAFs according to various exemplary embodiments as discussed above may be examples of apparatus 810. It should be noted that one of ordinary skill in the art would understand that apparatus 810 may include components or features not shown in FIG. 8. In addition, apparatus 820 may be a network, network entity, element of the core network, or element in a communications network or associated with such a network, such as a base station, an NE, or a gNB. For example, the gNBs according to various exemplary embodiments discussed above may be examples of apparatus 820. It should be noted that one of ordinary skill in the art would understand that apparatus 820 may include components or features not shown in FIG. 8.

According to various exemplary embodiments, the apparatus 810 may include at least one processor, and at least one memory, as shown in FIG. 8. The memory may store instructions that, when executed by the processor, cause the apparatus 810 to obtain at least one model for training or retraining based on measurement data of a network. The apparatus 810 may also be caused to determine that data collection is required prior to training or retraining the at least one model and receive one or more measurement reports that comprises at least one dataset from the data collection. The apparatus 810 may further be caused to train or retrain the at least one model based on all collected datasets, which comprises the at least one dataset from the data collection.

According to various exemplary embodiments, the apparatus 820 may include at least one processor, and at least one memory, as shown in FIG. 8. The memory may store instructions that, when executed by the processor, cause the apparatus 820 to determine that at least one model is underperforming and transmit, to a network entity, a request for training or retraining the at least one model. The apparatus 820 may be further caused to provide, to a network entity, at least one measurement report indicating performance of a user equipment and receive a trained or retrained model to be executed on the apparatus 820.

Various exemplary embodiments described above may provide several technical improvements, enhancements, and/or advantages. For instance, some exemplary embodiments may provide advantages and/or improvements to the NWDAF, gNB, and/or network to legacy MDT configuration procedures by, for example, implementing NWDAF and triggering data collection of RAN measurements through MDT for offline AI/ML model training or retraining.

In some example embodiments, apparatuses 810 and/or 820 may include one or more processors, one or more computer-readable storage medium (for example, memory, storage, or the like), one or more radio access components (for example, a modem, a transceiver, or the like), and/or a user interface. In some example embodiments, apparatuses 810 and/or 820 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 8, apparatuses 810 and/or 820 may include or be coupled to processors 812 and 822, respectively, for processing information and executing instructions or operations. Processors 812 and 822 may be any type of general or specific purpose processor. In fact, processors 812 and 822 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 812 (and 822) for each of apparatuses 810 and/or 820 is shown in FIG. 8, multiple processors may be utilized according to other example embodiments. For example, it should be understood that, in certain example embodiments, apparatuses 810 and/or 820 may include two or more processors that may form a multiprocessor system (for example, in this case processors 812 and 822 may represent a multiprocessor) that may support multiprocessing. According to certain example embodiments, the multiprocessor system may be tightly coupled or loosely coupled to, for example, form a computer cluster).

Processors 812 and 822 may perform functions associated with the operation of apparatuses 810 and/or 820, respectively, including, as some examples, precoding of antenna gain/phase parameters, encoding and decoding of individual bits forming a communication message, formatting of information, and overall control of the apparatuses 810 and/or 820, including processes illustrated in FIGS. 3-7.

Apparatuses 810 and/or 820 may further include or be coupled to memory 814 and/or 824 (internal or external), respectively, which may be coupled to processors 812 and 822, respectively, for storing information and instructions that may be executed by processors 812 and 822. Memory 814 (and memory 824) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 814 (and memory 824) can be comprised of any combination of random access memory (RAM), read only memory (ROM), static storage such as a magnetic or optical disk, hard disk drive (HDD), or any other type of non-transitory machine or computer readable media. The instructions stored in memory 814 and memory 824 may include program instructions or computer program code that, when executed by processors 812 and 822, enable the apparatuses 810 and/or 820 to perform tasks as described herein.

In certain example embodiments, apparatuses 810 and/or 820 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 812 and 822 and/or apparatuses 810 and/or 820 to perform any of the methods illustrated in FIGS. 3-7.

In some exemplary embodiments, an apparatus (e.g., apparatus 810 and/or apparatus 820) may include means for performing a method, a process, or any of the variants discussed herein. Examples of the means may include one or more processors, memory, controllers, transmitters, receivers, and/or computer program code for causing the performance of the operations.

Various exemplary embodiments may be directed to an apparatus, such as apparatus 810, that includes means for obtaining at least one model for training or retraining based on measurement data of a network. The apparatus may also include means for determining that data collection is required prior to training or retraining the at least one model and receiving one or more measurement reports that comprises at least one dataset from the data collection. The apparatus may further include means for training or retraining the at least one model based on all collected datasets, which comprises the at least one dataset from the data collection.

Certain exemplary embodiments may be directed to an apparatus, such as apparatus 820, that includes means for determining that at least one model requires updates and means for transmitting, to a network entity, a request for training or retraining the at least one model. The apparatus may also include means for providing, to the network entity, at least one measurement report indicating performance of a user equipment and means for receiving a trained or retrained model to be executed on the apparatus.

In some exemplary embodiments, apparatus 810 may also include or be coupled to one or more antennas 815 for receiving a downlink signal and for transmitting via an uplink from apparatus 810. Apparatuses 810 and/or 820 may further include transceivers 816 and 826, respectively, configured to transmit and receive information. The transceiver 816 and 826 may also include a radio interface that may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 816 and 826 may be respectively configured to modulate information on to a carrier waveform for transmission, and demodulate received information for further processing by other elements of apparatuses 810 and/or 820. In other example embodiments, transceivers 816 and 826 may be capable of transmitting and receiving signals or data directly. Additionally or alternatively, in some example embodiments, apparatuses 810 and/or 820 may include an input and/or output device (I/O device). In certain example embodiments, apparatuses 810 and/or 820 may further include a user interface, such as a graphical user interface or touchscreen.

In certain example embodiments, memory 814 and memory 824 store software modules that provide functionality when executed by processors 812 and 822, respectively. The modules may include, for example, an operating system that provides operating system functionality for apparatuses 810 and/or 820. The memory may also store one or more functional modules, such as an application or program, to provide additional functionality for apparatuses 810 and/or 820. The components of apparatuses 810 and/or 820 may be implemented in hardware, or as any suitable combination of hardware and software. According to certain example embodiments, apparatus 810 may optionally be configured to communicate with apparatus 820 via a wireless or wired communications link 830 according to any radio access technology, such as NR.

According to certain example embodiments, processors 812 and 822, and memory 814 and 824 may be included in or may form a part of processing circuitry or control circuitry. In addition, in some example embodiments, transceivers 816 and 826 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 810 and/or 820) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 810 and/or 820), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
ACK Acknowledgement
AMF Access and Mobility Function
CN Core Network
DL Downlink
EMBB Enhanced Mobile Broadband
gNB 5G or Next Generation NodeB
LMF Location Management Function
LTE Long Term Evolution
MaS Management Service
NR New Radio
NWDAF Network Data Analytics Function
OAM Operations and Management
OTT Over The Top
RAN Radio Access Network
RedCap Reduced Capability
RRC Radio Resource Control
TCE Trace Collection Entity
UDM Unified Data Management
UE User Equipment
UL Uplink
URLLC Ultra Reliable Low Latency Communication

We claim:

1. An apparatus, comprising:
at least one processor; and
at least one memory storing instructions that, when executed by the at least one processor, cause the apparatus at least to:
obtain, from a network entity, at least one machine learning model for training or retraining based on measurement data of a network;
determine that data collection is required prior to training or retraining the at least one machine learning model, and receive, from a network function, one or more measurement reports that comprises at least one dataset from the data collection;
determine whether additional assisted information from one or more network devices is required for training or retraining; and
train or retrain the at least one machine learning model based on all collected datasets, which comprises the at least one dataset from the data collection.

2. The apparatus according to claim 1, wherein the at least one memory and the instructions, when executed by the at least one processor, further cause the apparatus at least to:
receive one or more additional models to be trained or retrained in the future, wherein the obtained machine learning model for training or retraining is selected from a plurality of machine learning models accessible to the apparatus.

3. The apparatus according to claim 1, wherein the at least one memory and the instructions, when executed by the at least one processor, further cause the apparatus at least to:
transmit an acknowledgement to the network entity from which the apparatus obtained the at least one machine learning model for training or retraining.

4. The apparatus according to claim 1, wherein the at least one memory and the instructions, when executed by the at least one processor, further cause the apparatus at least to:
validate the trained model based on the one or more measurement reports.

5. The apparatus according to claim 1, wherein the at least one memory and the instructions, when executed by the at least one processor, further cause the apparatus at least to:
provide the trained model to a network device or a user equipment.

6. The apparatus according to claim 1, wherein the at least one memory and the instructions, when executed by the at least one processor, further cause the apparatus at least to:
receive, from the network entity, a request for retraining the at least one machine learning model;
transmit, to the network function, a request for training data for the at least one machine learning model to be retrained; and
retrain the at least one machine learning model based on the requested training data.

7. An apparatus, comprising:
at least one processor; and
at least one memory storing instructions that, when executed by the at least one processor, cause the apparatus at least to:
determine that at least one machine learning model requires updates;
transmit, to a network entity, a request for training or retraining the at least one machine learning model;
provide, to the network entity, at least one measurement report; and
receive, from the network entity, a trained or retrained machine learning model to be executed on the apparatus.

8. The apparatus according to claim 7, wherein the at least one memory and the instructions, when executed by the at least one processor, further cause the apparatus at least to:
receive one or more additional machine learning models to be trained or retrained in the future, wherein the obtained machine learning model for training or retraining is selected from a plurality of machine learning models accessible to the apparatus.

9. The apparatus according to claim 7, wherein the at least one memory and the instructions, when executed by the at least one processor, further cause the apparatus at least to:
validate the trained machine learning model based on the one or more measurement reports; and
execute the trained machine learning model.

10. The apparatus according to claim 7, wherein the at least one memory and the instructions, when executed by the at least one processor, further cause the apparatus at least to:
provide, to the network entity, a request for retraining the at least one machine learning model;
receive one or more measurement reports that comprise at least one dataset for retraining the at least one machine learning model; and
retrain the at least one machine learning model based on the one or more measurement reports.

11. A method, comprising:
obtaining, by an apparatus from a network entity, at least one machine learning model for training or retraining based on measurement data of a network;
determining that data collection is required prior to training or retraining the at least one machine learning model, and receiving, from a network function, one or more measurement reports that comprises at least one dataset from the data collection;
determining whether additional assisted information from one or more network devices is required for training or retraining; and
training or retraining the at least one machine learning model based on all collected datasets, which comprises the at least one dataset from the data collection.

12. The method according to claim 11, further comprising:
receiving one or more additional models to be trained or retrained in the future, wherein the obtained machine learning model for training or retraining is selected from a plurality of machine learning models accessible to the apparatus.

13. The method according to claim 11, further comprising:
transmitting an acknowledgement to the network entity from which the apparatus obtained the at least one machine learning model for training or retraining.

14. The method according to claim 11, further comprising:
validating the trained model based on the one or more measurement reports.

15. The method according to claim 11, further comprising:
providing the trained model to a network device or a user equipment.

16. The method according to claim 11, further comprising:
receiving, from the network entity, a request for retraining the at least one machine learning model;
transmitting, to the network function, a request for training data for the at least one machine learning model to be retrained; and
retraining the at least one machine learning model based on the requested training data.
